(19) United States
(12) Patent Application Publication
(10) Pub. No.: US 2013/0167743 A1
(43) Pub. Date: Jul. 4, 2013

(54) PRINTING UNIT CYLINDER AND SLEEVE FOR A PRINTING UNIT CYLINDER

(71) Applicants: Alfons GRIESER, Sielenbach (DE); Georg Schmid, Neusaess (DE)

(72) Inventors: Alfons GRIESER, Sielenbach (DE); Georg Schmid, Neusaess (DE)

(73) Assignee: manroland web systems GmbH, Augsburg (DE)

(21) Appl. No.: 13/541,221

(22) Filed: Jul. 3, 2012

(30) Foreign Application Priority Data
Jul. 7, 2011 (DE) 10 2011 106 886.8

(51) Int. Cl. B41F 3/02

(52) U.S. Cl. CPC B41F 3/02
USPC 101/375

(57) ABSTRACT

A printing unit cylinder and a sleeve for a printing unit cylinder is disclosed. The printing unit cylinder has an axial end section on the operator's side and a lateral surface having a plurality of openings through which compressed air can be passed so that a sleeve thereby widened can be pulled onto the lateral surface and pulled off of it over the axial end section. A noise reduction structure is provided on the axial end section for reducing the noises generated by compressed air emerging between the sleeve and the lateral surface. The noise reduction structure is equipped to support an inside circumferential surface of the sleeve on the axial end section over at least a portion of its circumference, so that vibrational excitation of the sleeve based on the escaping compressed air is prevented.

This application claims the priority of German Patent Document No. DE 10 2011 106 886.8, filed Jul. 7, 2011, the disclosure of which is expressly incorporated by reference herein.

### BACKGROUND AND SUMMARY OF THE INVENTION

The invention relates to a printing unit cylinder, in particular a plate cylinder or a transfer cylinder of an offset printing press, and a sleeve for a printing unit sleeve, in particular a plate cylinder or a transfer cylinder of an offset printing machine.

A printing unit cylinder and a sleeve of the type defined in the introduction are known from German Patent Document No. DE 101 15 877 A1.

In the case of printing unit cylinders of offset printing presses provided in a sleeve design, the thin-walled sleeves, i.e., sleeve-shaped cylinder covers, are expanded by compressed air for the purpose of assembly and dismantling. Because of the difference between the inside diameter of the sleeve and the outside diameter of the cylinder body defined by the lateral surface, a surface pressure which ensures secure seating of the cylinder sleeve is ensured in the assembled state.

When applying and removing the sleeve, compressed air is forced through a system of holes into the gap between the sleeve and the lateral surface, expanding the inside diameter of the sleeve to such an extent that it results in play between the sleeve and the lateral surface of the cylinder body. The compressed air can escape through the gap at each end of the sleeve. The sleeve and the column of air escaping are excited to vibration and generate a loud high-frequency whistling sound that can reach sound levels of more than 120 dB.

The object of the present invention is to provide a printing unit cylinder and to provide a cylinder sleeve so that noises caused by vibration of the sleeve are reduced and can in particular be prevented.

According to a first aspect of the invention, a printing unit cylinder having an axial end section on the operator's side and a lateral surface having a plurality of openings through which compressed air can be passed is provided, so that a cylinder sleeve, which can be widened thereby, can be pulled onto and off of the lateral surface via the axial end, wherein noise reduction structure is provided on the axial end section for reducing noises produced by the compressed air passing between the cylinder sleeve and the lateral surface. The printing unit cylinder according to the invention is characterized in that the noise reduction structure is equipped to support an inside circumferential surface of the cylinder sleeve over at least a portion of the circumference on the axial end section, thereby preventing vibrational excitation of the cylinder sleeve due to the compressed air passing by.

In other words, the noise reduction structure on the axial end section on the operator's side is in supporting contact with the inside circumferential surface of the cylinder sleeve, thereby reducing and in particular preventing noises caused by vibration of the cylinder sleeve in the area of the axial end section on the operator's side.

In one embodiment of the printing unit cylinder according to the invention, the noise reduction structure is equipped to rigidly support the inside circumferential surface of the cylinder sleeve.

In another embodiment of the printing unit cylinder according to the invention, the noise reduction structure on the axial end section has a subsection with an outside diameter corresponding approximately to the inside diameter of the unwidened cylinder sleeve. The outside diameter of the supporting subsection preferably corresponds to the inside diameter of the cylinder sleeve that has not been widened and/or installed minus 0.03 mm to 0.05 mm.

According to one embodiment of the printing unit cylinder according to the invention, the noise reduction structure is equipped to provide spring support for the inside circumferential surface of the cylinder sleeve.

According to another embodiment of the printing unit cylinder according to the invention, on the axial end section, the noise reduction structure includes a plurality of spring elements distributed on the circumference, which are equipped to press the inside circumferential surface of the cylinder sleeve radially outward with a predetermined spring force.

According to a second aspect of the invention, a cylinder sleeve for a printing unit cylinder having one axial end on the operator's side and one axial end not on the operator's side (e.g., on the drive end) as well as a lateral surface having a plurality of openings through which compressed air can be supplied, such that the cylinder sleeve has: two axial end sections and an inside circumferential surface, which defines the inside diameter of the cylinder sleeve that is smaller than the outside diameter of the lateral surface of the printing unit cylinder and can be adjusted by compressed air coming out of the openings in the lateral surface to form a widened state, in which the inside diameter of the sleeve is larger than the outside diameter of the lateral surface of the printing unit cylinder, so the cylinder sleeve can be pulled onto and off of the lateral surface via the axial end at the operator's side. The sleeve according to the invention is characterized in that the inside circumferential surface has a number (greater than zero) of support sections distributed around the circumference, defining an inside circle with a diameter which, in the widened state of the inside diameter of the cylinder sleeve, is not greater than (i.e., is less than or the same as) the outside diameter of the lateral surface of the printing unit cylinder, and wherein the support sections are arranged axially so that they can be brought into contact with the printing unit cylinder and/or are in contact with the printing unit cylinder when the cylinder sleeve is applied to the printing unit cylinder.

Due to the contact between the support sections and the printing unit cylinder, vibrations of the cylinder sleeve are reduced and thus the noise caused by these vibrations is reduced and in particular prevented.

In one embodiment of the sleeve according to the invention, the support sections are provided on the axial end section assigned to the axial end of the printing unit cylinder not on the operator's side.

Thus vibration of the cylinder sleeve and thus noise thereby produced on the axial end section of the cylinder sleeve are reduced and prevented in particular. Together with the printing unit cylinder according to the first aspect of the invention this creates a printing unit cylinder-sleeve arrangement in which noise caused by vibration of the sleeve is reliably reduced and prevented in particular on both the operator's side and the non-operator's side.

In another embodiment of the sleeve according to the invention, the support sections are provided symmetrically on both axial end sections, which reduces the technological complexity with regard to the alignment of the undressed sleeves for cylinders.

According to yet another embodiment of the sleeve according to the invention, each support section is designed in the form of a protrusion pointing radially inward. As an alternative to that, each axial end section having the support sections may taper freely in a polygonal cross-section, so that the support sections are formed by connecting sections between the corners of the polygon and/or the polygonal cross-section.

In the case in which the number of support sections per axial end section is one, a peripheral groove may be provided in the cylinder sleeve.

The invention also extends explicitly to those embodiments which are not obtained by combining features from explicit references in the claims back to previous claims, so that the disclosed features of the invention may be combined with one another in any desired manner—inasmuch as this is technically feasible.

The invention will now be described in greater detail below on the basis of preferred embodiments and with reference to the accompanying figures:

### BRIEF DESCRIPTION OF THE DRAWINGS

FIG. 1 shows a schematic view of a printing unit cylinder of an offset printing machine with the cylinder sleeve partially applied.

FIG. 2 shows a schematic partial view of a printing unit cylinder of an offset printing press having a sleeve according to one embodiment of the invention.

FIG. 3 shows a schematic partial view of a printing unit cylinder of an offset printing press having a sleeve according to another embodiment of the invention.

FIG. 4 shows a schematic partial view of a printing unit cylinder of an offset printing press having a sleeve according to yet another embodiment of the invention.

FIG. 5 shows a schematic partial view of a sleeve on a printing unit cylinder of an offset printing press according to one embodiment of the invention.

FIG. 6 shows a schematic perspective partial view of a sleeve and a printing unit cylinder of an offset printing press according to another embodiment of the invention.

### DETAILED DESCRIPTION OF THE DRAWINGS

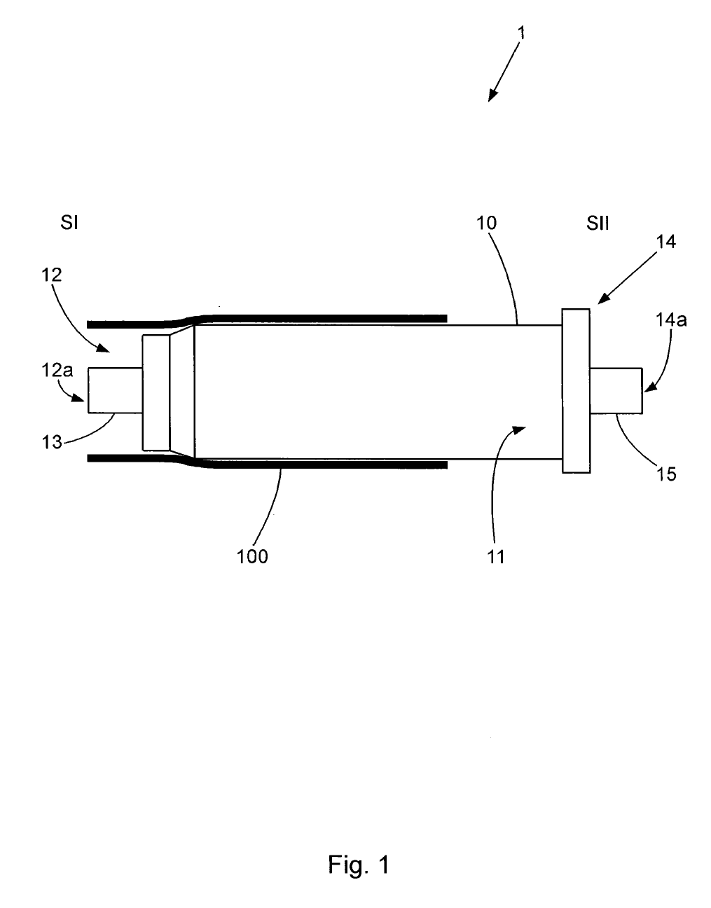

FIG. 1 shows a schematic view of a printing unit cylinder 1 of a printing couple (not shown completely) of an offset printing press (not shown completely) having the sleeve 100 partially applied.

The printing unit cylinder 1 is preferably designed as a form cylinder (in particular as a plate cylinder) or as a transfer cylinder (in particular a rubber cylinder).

The printing unit cylinder 1 has a cylinder body 10 with a pressure-responsive lateral surface 11 and a first axial end section 12 having a first journal 13 rotatably mounted in a frame (not shown) on the operator's side SI of the printing couple, and also has a second axial end section 14 having a second journal 15 rotatably mounted in a frame (not shown) on a drive side, i.e., a non-operator's side SII of the printing couple.

The axial end section 12 on the operator's side (first axial end section) defines an axial end 12a on the operator's side on the first journal 13, and the axial end section 14 (second axial end section) which is not on the operator's side defines an axial end 14a not on the operator's side on the second journal 15.

The inventors have discovered that whistling noises may occur on the operator's side SI and/or on the non-operator's side SII, depending on the pressure distribution in the gap and the axial position of the cylinder sleeve 100.

Taking this finding into account, embodiments of the invention are described below with reference to FIG. 1, where the same or similar components are labeled with the same reference characters, and additions to and modifications of these are labeled with additional and/or modified reference characters. In other words, the embodiments according to the invention are designed according to the basic shape shown in FIG. 1.

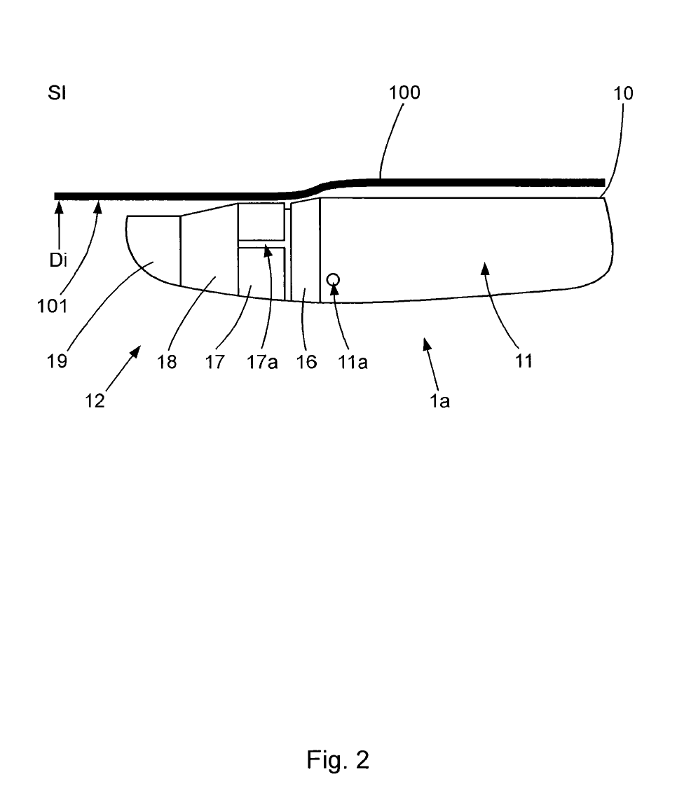

With reference to FIGS. 1 and 2, a printing unit cylinder 1a will now be described according to one embodiment of the invention.

The printing unit cylinder 1a has a plurality of openings and/or air holes 11a (only one is shown) in its lateral surface 11, such that compressed air can be passed through them, so that the cylinder sleeve 100, which can therefore be inflated (because it has thin walls), can be pulled onto and off of the lateral surface 11 via the axial end section 12 on the operator's side.

The axial end section 12 on the operator's side has a conically widened zone 16 starting from the lateral surface 11 in the direction of the axial end 12a on the operator's side to facilitate the widening of cylinder sleeve 100, and also has a support zone 17, a push-fit cone and/or centering cone 18 to facilitate pulling the sleeve 100 onto the cylinder and has a tapered zone 19 before the first journal 13.

The support zone 17 has one or more blow-off grooves 17a for compressed air distributed uniformly over its circumference. The support zone 17 forms noise reduction structure for reducing the noise produced by the compressed air emerging between the sleeve 100 and the lateral surface 11.

To this end, the support zone 17 is equipped to support an inside circumferential surface 101 of sleeve 100 over at least a portion of the circumference on the axial end section 12 on the operator's side, thereby preventing vibrational excitation of cylinder sleeve 100 because of the escaping compressed air.

The support zone 17 provides a rigid and/or inflexible support for the inside circumferential surface 101 of the sleeve 100 in pulling the sleeve 100 onto and off of the cylinder in the area of the axial end section 12 on the operator's side, thereby reliably preventing vibrational excitation of sleeve 100.

The support zone 17 may have a circular or polygonal cross-section. In the case of the polygonal cross-section, the blow-off grooves 17a may be omitted because the compressed air can escape through intermediate areas between the contact areas of the support zone 17 with the inside circumferential surface 101 of the sleeve 100.

The support zone 17, which forms a subsection of the axial end section 12, has an outside diameter corresponding approximately to the inside diameter Di of the unwidened sleeve 100. The outside diameter of the support zone 17 is preferably designed according to the formula:

outside diameter (support zone 17)=Di−0.03 mm to 0.05 mm

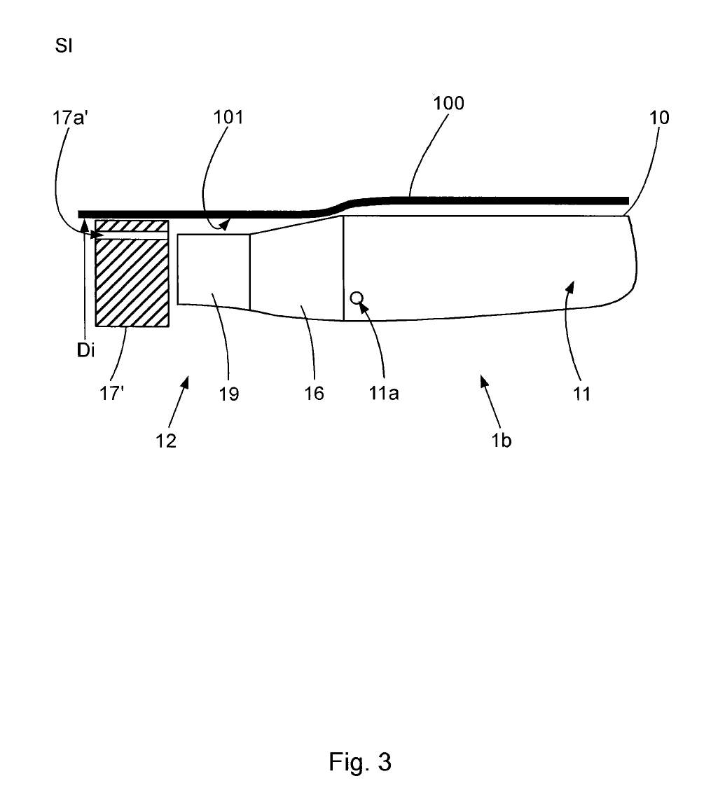

FIG. 3 shows a printing unit cylinder 1b according to a modification of the embodiment of the invention shown in FIG. 2.

As shown in FIG. 3, a support zone 17′ having one or more blow-off grooves 17a′ for compressed air, distributed uniformly around the circumference, is mounted on the axial end section 12 on the operator's side and/or on the cylinder barrel.

In the combination of the embodiments according to FIGS. 2 and 3, vibrational excitation of the cylinder sleeve 100 by the emerging compressed air is suppressed due to the design of the diameter ratios in the area of the push-fit zone according to the invention. The outside diameter of the support zone 17, 17′ arranged upstream from the widened zone 16 in the direction of pulling the sleeve onto the cylinder corresponds to the inside diameter Di of the sleeve 100, which has not been applied, minus 0.03 mm to 0.05 mm. The support 17, 17′ may be an integral component of the printing unit cylinder la (integrated into the cylinder geometry) or may be mounted on the printing unit cylinder 1b (retrofitability). The support zone 17, 17′ may be designed as a disk or a polygon. Blow-off grooves 17a, 17a′ or axial holes and/or flattened areas provide venting of the support zone 17, 17′.

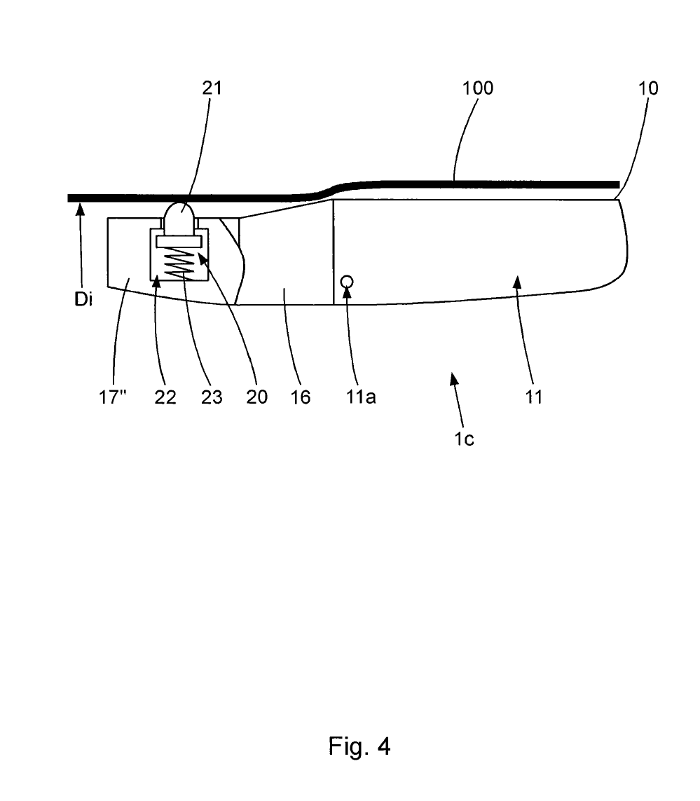

With reference to FIGS. 1 and 4, a printing unit cylinder 1c according to yet another embodiment of the invention will now be described.

The printing unit cylinder 1c shown in FIG. 4 is designed like the printing unit cylinder 1a shown in FIG. 2 except for a few differences, which is why only these differences are described below.

In the case of the printing unit cylinder 1c shown in FIG. 4, the axial end section 12 on the operator's side is designed so that it has a conically widened zone 16 starting from the lateral surface 11 in the direction of the axial end 12a on the operator's side to facilitate the widening of the sleeve 100 and also has a support zone 17″ which forms the noise reduction structure.

The support zone 17″ is equipped to support the inside circumferential surface 101 of the sleeve 100 elastically. To this end, a plurality of spring elements 20 (and/or elastic support elements) distributed around the circumference are provided in the support zone 17″, these elements being equipped to press at a predetermined spring force radially outward against the inside circumferential surface 101 of the sleeve 100.

According to the embodiment shown here, each spring element 20 has a stamp 21 protruding radially outward, a recess 22 holding the stamp 21 and a compression spring 23, which supports the stamp 21 toward the outside radially at a prestressing force in the recess 22. According to one modification, the compression spring 23 may be omitted when the stamp 21 is made of an elastic material such as an elastomer material.

In conclusion, vibrational excitation of the sleeve 100 due to the escaping compressed air can be prevented by one or more elastic support elements or elastomer elements (spring element(s) 20). The spring elements 20 are integrated into the printing unit cylinder lc at uniform intervals around the circumference before the widened zone 16.

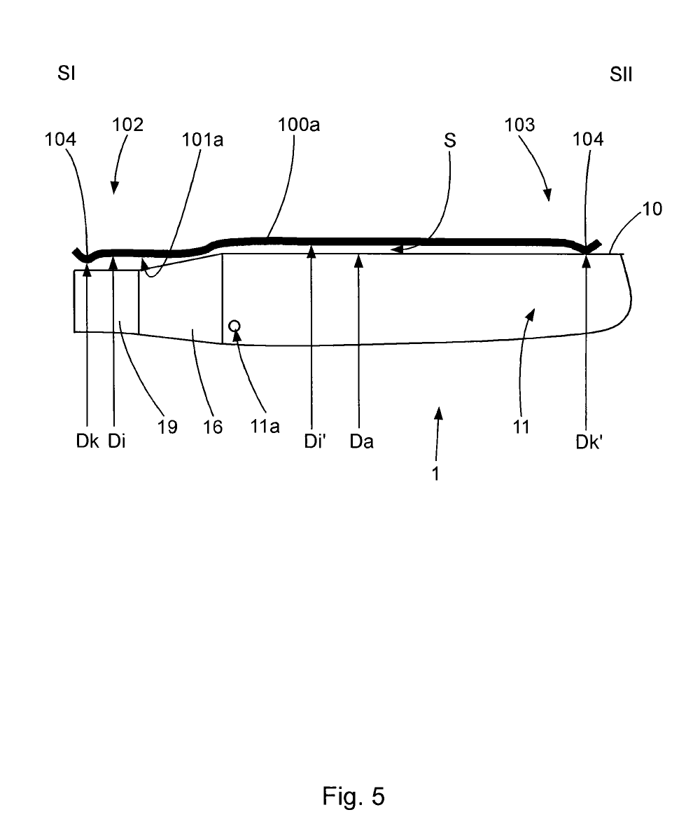

With reference to FIGS. 1 and 5, a sleeve according to one embodiment of the invention will now be described.

FIG. 5 shows a schematic partial view of a sleeve 100a on a printing unit cylinder 1 of a printing couple (not shown completely) of an offset printing press (not shown completely) according to one embodiment of the invention. As shown in FIG. 5, the lateral surface 11 again has a plurality of openings 11a through which compressed air can pass.

The sleeve 100a has two axial end sections 102, 103 and an inside circumferential surface 101a which defines an inside diameter Di of the sleeve 100a which is smaller than the outside diameter Da of the lateral surface 11 of the printing unit cylinder 1 and can be adjustably changed by compressed air coming out of the openings 11a in the lateral surface 11 to form a widened state in which the inside diameter, i.e., the widened inside diameter Di', is larger than the outside diameter Da of the lateral surface 11 of the printing unit cylinder 1, so that the sleeve 100a can be pulled onto and off of the lateral surface 11 by pulling it over the axial end 12a on the operator's side (see FIG. 1) of the printing unit cylinder 1. A gap and/or a mounting plane S is formed between the lateral surface 11 of the printing unit cylinder 1 and the inside circumferential surface 101a of the sleeve 100a due to the widening of the sleeve 100a.

According to the invention, the inside circumferential surface 101a has a number (greater than zero) of support sections 104 distributed on the circumference and at at least one of the two axial end sections 102, 103, these support sections defining an inside circle with a diameter Dk, which is not larger than the outside diameter Da of the lateral surface 11 of the printing unit cylinder 1 in the widened state of the inside diameter Di′ of the sleeve 100a, and the support sections are arranged axially so that they can be brought into contact with the lateral surface 11 of the printing unit cylinder 1.

In other words, a widened diameter Dk′ of the inside circle formed by the support sections 104 is smaller than or equal to the outside diameter Da of the lateral surface 11 of the printing unit cylinder 1.

According to variants of this embodiment of the invention, the support sections 104 may be provided on both axial end sections 102, 103 of the sleeve 100a symmetrically as shown in FIG. 5 or they may be provided on the axial end section 103, which is provided on the axial end 14a (see FIG. 1) of the printing unit cylinder 1 not on the operator's side and/or is the closest to that in the state of the sleeve 100a when it has been pulled onto the cylinder.

According to the embodiment of the invention shown in FIG. 5, each support section 104 is designed in the form of a protrusion pointing radially inward.

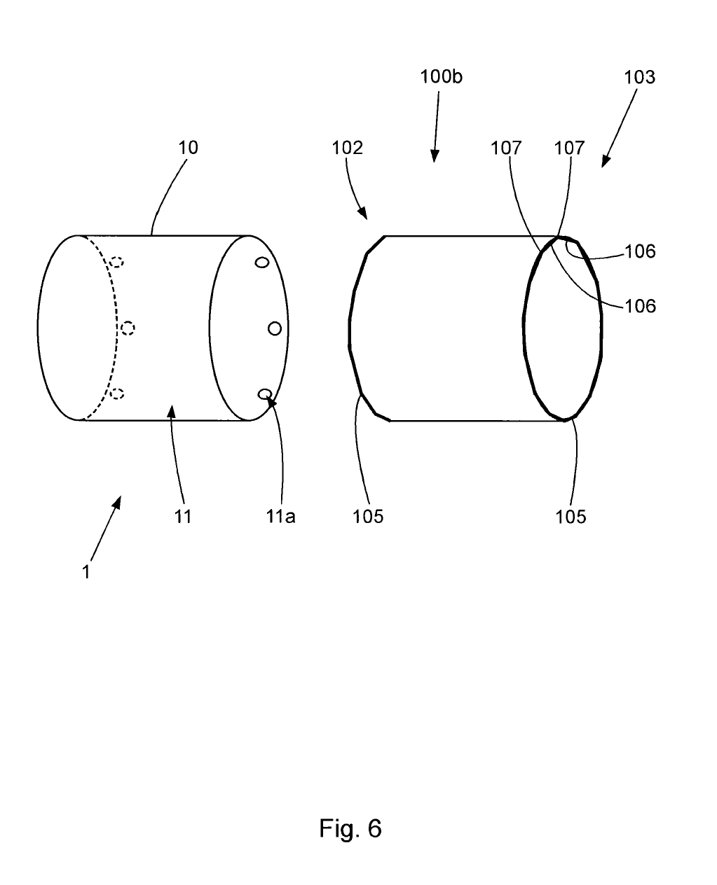

Finally, FIG. 6 shows a sleeve 100b according to a modification of the embodiment of the invention shown in FIG. 5. According to FIG. 6, each axial end section having support sections tapers freely in a polygonal cross-section 105, so that the support sections are formed by connecting sections 106 between corners 107 of the polygon.

In combining the embodiments according to FIGS. 5 and 6, one or more support nubs and/or support sections 104; 106 are arranged over the circumference according to the invention in order to suppress vibrational excitation of the sleeve end in particular and/or the axial end section 103 not on the operators end in the vented state. Support sections 104, 106 are also in contact with the lateral surface 11 in the vented state and prevent noise emission due to vibrational excitation of the escaping compressed air.

The same effect is also achieved by element (polygonal cross-section 105) which is cut into the edge of the sleeve 100b and converts the cylindrical sleeve geometry into a polygon. The polygon is adapted to the cylinder geometry when the sleeve 100b is pulled onto the cylinder. Some areas (support sections 106) of increased surface pressure are formed and are not raised in the vented state.

The support sections 104, 106 may be present symmetrically on both axial end sections 102, 103 or just on the axial end section 103 not on the operator's side.

### LIST OF REFERENCE NUMBERS

1 printing unit cylinder
1a printing unit cylinder
1b printing unit cylinder
1c printing unit cylinder
10 cylinder body
11 lateral surface
11a openings
12 axial end section
12a axial end
13 journal
14 axial end section
14a axial end
15 journal
16 widened zone
17 support zone
17′ support zone
17″ support zone
17a blow-off groove
17a′ blow-off groove
18 push-fit cone
19 tapered zone
20 spring element
21 stamp
22 recess
23 compression spring
100 cylinder sleeve
100a cylinder sleeve
100b cylinder sleeve
101 inside circumferential surface
101a inside circumferential surface
102 axial end section
103 axial end section
104 support section
105 polygonal cross-section
106 support section
107 corner
SI operator's side
SII non-operator's side
S gap
Da outside diameter
Di inside diameter
Di′ widened inside diameter
Dk diameter
Dk′ widened diameter

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing unit cylinder, comprising:
an axial end section on an operator side and a lateral surface having a plurality of openings through which compressed air is passable; and
a noise reduction structure disposed on the axial end section, wherein a noise generated by compressed air emerging between a sleeve disposed on the lateral surface and the lateral surface is reduceable by the noise reduction structure;
wherein an inside circumferential surface of a sleeve disposed on the lateral surface is supportable at the axial end section by the noise reduction structure over at least a portion of a circumference of the noise reduction structure.

2. The printing unit cylinder according to claim 1, wherein the inside circumferential surface of a sleeve disposed on the lateral surface is rigidly supportable at the axial end section by the noise reduction structure.

3. The printing unit cylinder according to claim 2, wherein the noise reduction structure includes a subsection with an outside diameter that corresponds approximately to an inside diameter of a sleeve that is disposed at the axial end section that is not widened by compressed air.

4. The printing unit cylinder according to claim 1, wherein the noise reduction structure includes a spring element.

5. The printing unit cylinder according to claim 4, wherein the noise reduction structure includes a plurality of spring elements distributed around the circumference of the noise reduction structure.

6. A sleeve for a printing unit cylinder, comprising:
two axial end sections; and
an inside circumferential surface which defines an inside diameter of the sleeve, wherein the inside circumferential surface has a plurality of support sections disposed on at least one of the two axial end sections.

7. The sleeve according to claim 6, wherein the support sections are disposed on the two axial end sections.

8. The sleeve according to claim 7, wherein the support sections are disposed symmetrically on the two axial end sections.

9. The sleeve according to claim 6, wherein each of the plurality of support sections is a protrusion pointing radially inward.

10. The sleeve according to claim 6, wherein each of the plurality of support sections is a connecting section between corners of a polygon.

11. A printing unit cylinder in combination with a sleeve, comprising:
a printing unit cylinder with an axial end section and a lateral surface having a plurality of openings through which compressed air is passable;
a noise reduction structure disposed on the axial end section of the printing unit cylinder; and
a sleeve disposed on the printing unit cylinder;
wherein a noise generated by compressed air emerging between the sleeve and the lateral surface is reduceable by the noise reduction structure;
and wherein an inside circumferential surface of the sleeve is supported at the axial end section by the noise reduction structure over at least a portion of a circumference of the noise reduction structure.
